(19) United States
(12) Patent Application Publication
(10) Pub. No.: US 2024/0341293 A1
(43) Pub. Date: Oct. 17, 2024

(54) A LEAD-FREE WEIGHTS AND RELATED METHODS

(71) Applicants: Kris Ann Englebrecht, Auburn, CA (US); William Elman Nelson, III, Auburn, CA (US)

(72) Inventors: Kris Ann Englebrecht, Auburn, CA (US); William Elman Nelson, III, Auburn, CA (US)

(21) Appl. No.: 18/658,858

(22) Filed: May 8, 2024

Related U.S. Application Data
(63) Continuation of application No. 18/135,033, filed on Apr. 14, 2023.

(51) Int. Cl. A01K 95/00

(52) U.S. Cl. CPC A01K 95/005

(57) ABSTRACT

Disclosed is a lead-free weight and a method of making the same. The weights are constructed from a combination of mineral and/or metal elements, coarse granular element, and at least one naturally-occurring binder. The fishing weights can be made in various shapes. The weights are environmentally friendly and disintegrate within a few weeks when lost to a body of water or the surrounding area.

### FIELD OF THE INVENTION

The present invention relates generally to dissolvable, lead-free weights and methods of making and using the same.

### BACKGROUND OF THE INVENTION

Conventional fishing weights are composed of lead, which is a problematic heavy metal element that can cause significant environmental problems due to its toxicity to biological systems. Fishing weights are often lost due to tangling or catching of fishing line, breakage during the process of reeling in a fish, or by failure of the weight attachment to fishing line. Lost fishing weights deposit in the sediment at the bottom of a body of water or in the soil located around the body of water. Lead accumulation in the soil and sediment can result, and cause toxicity in animals in the surrounding environment.

Lead fishing weights pose a significant threat to loons and other wildlife due to lead poisoning, which occurs when animals ingest the weights mistaking them for prey or while consuming prey that has ingested the weights. Loons, known for their diving habits to forage for food, are particularly at risk. They may swallow lead weights along with their catch or pick them up from lakebeds, mistaking them for pebbles used in their digestion process. Once ingested, the lead rapidly affects the loon's digestive system, leading to a painful and often fatal condition known as lead toxicosis. This ingestion of lead also threatens other bird species and aquatic wildlife, causing similar health issues and contributing to declines in population.

The use of lead in the manufacturing of fishing weights is common and it will be restricted in fishing weights. There is a continuing need for effective lead-free fishing weights.

### SUMMARY OF THE INVENTION

The present invention provides a novel, lead-free weights (e.g., fishing weights) created by a novel composition and method of manufacturing the same. The weight includes only environmentally friendly constituents that provide a practical and effective weight (e.g., a fishing weight) when formed according to the presently disclosed methods. The weights disclosed herein are appropriate and effective for use in any aquatic or marine environment. The structure of the weight is also operable to disintegrate over time if lost in the aquatic or marine environment, with the components thereof posing no hazard to any life or biological processes.

The disclosed lead-free weights may include a mineral constituent that may be a naturally occurring mineral ore, metal, or combination thereof. The mineral ore and/or the metal may have a specific gravity in a range of about 5.5 kg/m³ to about 7 kg/m³. In some embodiments, the weight may include one mineral constituent or a combination of mineral constituents. In some embodiments, the weight may include one kind of metal or a combination of kinds of metals. In some embodiments, the weight may include a combination of (1) one or more mineral constituents, and (2) one or more kinds of metal constituents.

The mineral ore may have a crystal structure or a synthetic reproduction of such a mineral. In some embodiments, the mineral constituent may have a relatively low hardness in a range of in a range of about 4 D to about 5 D on the Shore D scale. The mineral constituent may include one or more mineral ores or synthetic versions thereof. In some embodiments, the mineral constituent may be naturally occurring Scheelite ore and/or a synthetic equivalent thereof. In some embodiments, the mineral constituent may include one or more of Scheelite, Wolframite, Cassiterite, Chromite, Ilmenite, and/or Rutile.

The composite weights of the present invention may incorporate metal particles or fragments composed of tungsten, steel, and/or iron. These metals are known for their significant density and environmental safety, replacing traditional lead components to align with eco-friendly standards. Tungsten, with its high density and minimal environmental impact, serves as an ideal substitute for lead, ensuring the weight achieves the necessary density for effective fishing while being environmentally benign. Iron and steel, both robust and readily available materials, may enhance the structural integrity of the weight without negative environmental impact. These metals are incorporated in finely divided forms, likely ranging in size similar to the specified mineral constituent particles, to ensure uniform distribution within the composite matrix. This metal particles may allow for a balanced weight distribution, improving the weight's performance.

The particles of the mineral constituent(s) and metal constituents may include an average size of about 0.075 mm to about 0.25 mm (e.g., about 0.1 mm to about 0.15 mm, about 0.125 mm). The size of the particles of the mineral constituent enables the particle interaction between them and other constituents in the mixture to have more surface interactions between the mineral particles and coarse granular material in the mixture that provides higher required shear stress or tension to disintegrate the constituents.

The weights may further include a coarse granular material that may act as part of a filling matrix between the mineral constituent (e.g., coarse sand, pulverized stone, and/or granular calcium carbonate). The coarse granular material may have an average size in a range of about 0.05 mm to about 0.5 mm (e.g., about 0.1 mm to about 0.3 mm).

The weight may also include one or more natural binders that are operable to hold the binders may include a natural pine resin, beeswax, or other natural binder. The natural binder(s) may flow between the mineral and coarse granular particles to provide an adhesive matrix between the particles. Natural binders like pine resin or beeswax, the metal particles may be bound within a matrix that includes coarser granular materials such as sand or pulverized stone. This matrix may be effective in maintaining the structural cohesion of the weight but also designed to gradually disintegrate. This disintegration occurs without posing any hazard to aquatic life or the environment, as all constituents are selected based on their eco-friendly properties.

The method of the present invention for forming lead-free weights may include the steps of combining the components in particular proportions including about 65% to about 85% mineral constituent by volume (e.g., about 70% to about 80% by volume, about 75% by volume), about 10% to about 20% coarse granular material by volume (e.g., about 12.5% to about 17.5% by volume, about 15% by volume), and about 5% to about 15% of the natural binder by volume (e.g., about 7.5% to about 12.5% by volume, about 10% by volume). The mixture may be physically mixed together. The mixture may be heated to a temperature in a range of about 260° F. to about 280° F. (e.g., about 265° F. to about 275° F., about 275° F.) in order to melt the natural binder and allow the constituents to flow and intermingle in a substantially even and uniform distribution. Once the mixture has been heated to the target temperature and mixed into a uniform mixture, the mixture may be placed in a mold structure having the desired shape and dimensions of the lead-free weight.

In some embodiments, a mold may be employed to form the weight. Unlike the molds used for lead weights, in which lead is heated to 800° F., high temperature mold structures are not needed. The mixture for the instant invention can be molded in a mold structure that is fabricated from various materials. For example, a wood mold can be formed on a lathe. A polymeric mold may also be formed through three-dimensional printing, mold injection fabrication, or other method. In some embodiments, the mold may have cells having sufficient volume to hold the entire fishing weight shape and a mold press that has a complementary shape to the mold cell and that is operable to be inserted into the mold cell over the mixture to apply pressure to the mixture and aid in forming a compressed structure that can maintain its integrity.

Once the constituents are added to the mold, the mixture is pressure molded into mold at the target temperature with applied pressure with a mold press (e.g., manual or automated) at a pressure of about 10 lb/in to about 20 lb/in (e.g., about 12.5 lb/in to about 17.5 lb/in, about 15 lb/in). In some examples, heating the mixture results in the pine resin forming a film around the Scheelite ore, reducing reactivity of the ore with other materials, including water or salt water. The pine resin also flows between the mineral constituents and granular material to fill in between and bind the dry mixture together in a reliably congealed and integral structure once cooled. Once the weight is fully fledged a hole may be drilled or otherwise formed into the weight.

In some embodiments, the mold may have two-part construction that allowed the dry constituents to be placed in a lower portion of the mold (the bed), which may include 50% or greater of the volume of the weight and an upper portion (a cap) that encloses the admixture in the mold. The cap may have a pour hole formed through the center thereof. The pour hole may have a diameter in a rage of about 3 mm to about 12 mm that allows the binders to be poured into the mold onto the admixture. A rod may then be placed through the pour hole in order to create a passage through the weight to allow fishing line to be threaded therethrough. The mold may be then placed in an oven and warmed to the target temperature.

It is an objective of the invention is to provide a weight that will not pollute or otherwise harm the environment, wildlife, or people that come in contact with the weights.

Another objective of the invention is to provide a method of manufacturing a lead-free weight that is safe for disposal in the environment.

Another objective of the invention is to provide a lead-free fishing weight that performs equally well to a conventional fishing weight.

Another objective of the invention is to provide a lead-free weight that is inexpensive to manufacture.

Another objective of the invention is to provide a lead-free weight that is designed to degrade when left in water.

It is an aspect of the present invention to provide a method of constructing lead-free weight comprising: forming a mixture including about 65% to about 85% metal constituent by volume, about 10% to about 20% coarse granular material by volume; about 5% to about 15% natural binder by volume; and heating the admixture to temperature in a range of about 260° F. to about 280° F.; and allowing the weight to set for a pre-determined period. The metal element may include one or more of tungsten, iron, and/or steel. The granular element may include one or more of coarse sand, pulverized stone, and granular calcium carbonate. The mineral constituent may have an average size in a range of about 0.075 mm to about 0.25 mm. The metal constituent may have an average size in a range of about 0.075 mm to about 0.25 mm. The coarse granular material may have an average size in a range of about 0.05 mm to about 0.5 mm. The first naturally-occurring binder may be pine resin. A second naturally-occurring binder may be included in the mixture beeswax. The first naturally occurring binder may be added in an amount that is between about 5% and about 15% by volume. The second naturally occurring binder may be added in an amount that is between about 2.5% and about 7.5% of the mixture by volume. The method may further include placing the mixture in a mold prior to heating the mixture. The mixture may be allowed to set in the mold for a pre-determined period prior to removal from the mold. The method may further include placing the mixture in a pre-selected mold and allowing the admixture to cool for a pre-determined period.

It is a further aspect of the present invention to provide a lead-free fishing weight comprising a pre-determined shape operable to be attached to fishing line comprising about 65% to about 85% of a mineral constituent and/or metal constituent by volume; about 10% to about 20% coarse granular material by volume; and a naturally occurring binder coating the mineral constituent and the coarse granular constituent on the exterior of the weight and being present interstitially between the mineral constituent and the coarse granular constituent. The mineral element may include one or more of Scheelite, Wolframite, Cassiterite, Chromite, Ilmenite, and Rutile. The mineral element may be Scheelite. The metal element may include one or more of tungsten, iron, and/or steel. The granular element may include one or more of coarse sand, pulverized stone, and granular calcium carbonate. The mineral constituent may have an average size in a range of about 0.075 mm to about 0.25 mm. The metal constituent may have an average size in a range of about 0.075 mm to about 0.25 mm. The coarse granular material may have an average size in a range of about 0.05 mm to about 0.5 mm. The first naturally-occurring binder may be pine resin. The second naturally-occurring binder may be beeswax. The first naturally occurring binder may be added in an amount that is between about 5% and about 15% of the mixture by volume. A second naturally occurring binder may be added in an amount that is between about 2.5% and about 7.5% of the dry mixture by volume.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1A provides a view of a method of making a lead-free weight according to an embodiment of the present invention.

FIG. 1B provides a view of a method of making a lead-free weight according to an embodiment of the present invention.

FIG. 2A provides a view of a method of making a lead-free weight according to an embodiment of the present invention.

FIG. 2B provides a view of a method of making a lead-free weight according to an embodiment of the present invention.

FIG. 3A provides a view of a lead-free weight according to an embodiment of the present invention.

FIG. 3B provides a view of a lead-free weight according to an embodiment of the present invention.

FIG. 3C provides a view of a lead-free weight according to an embodiment of the present invention.

FIG. 3D provides a view of a lead-free weight according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

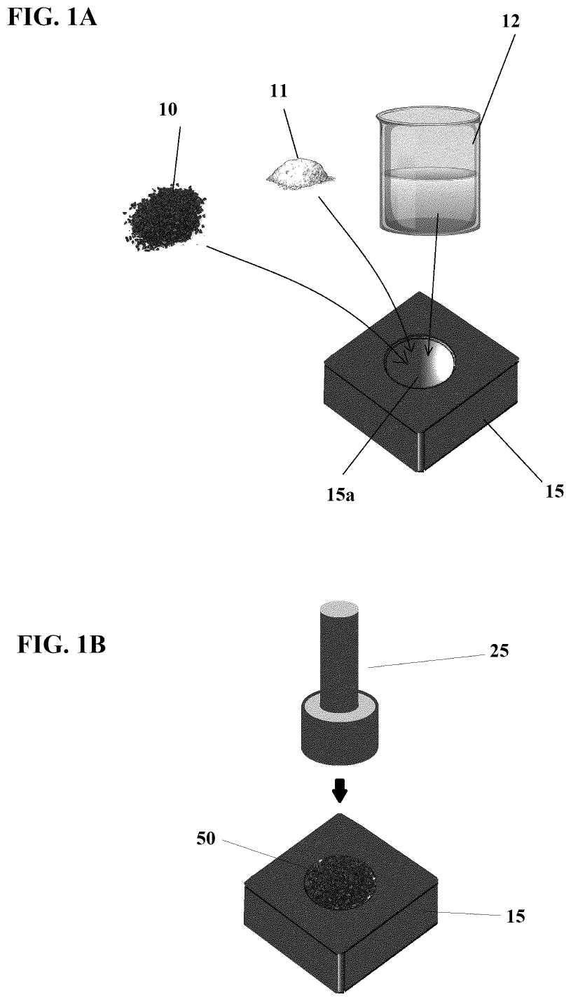

The present invention concerns a novel lead-free weight created by a novel composition and method of manufacturing the same. FIGS. 1A-1B provides views of an exemplary method of manufacturing a lead-free fishing weight according to the present invention. The exemplary ingredients including the mineral and/or metal constituent 10, the coarse granular material 11, and a naturally-occurring binder 12 are prepared for mixture in a mold. The mineral constituent and the coarse granular material may be combined in a dry mixture that includes from about 65% to about 85% mineral and/or metal constituent by volume and about 10% to about 20% coarse granular material by volume. One or more binders 12 may be heated to or above its melting point and may be combined with the dry mixture. The one or more binders 12 may be pine resin, which has a melting point in a range of about 155° F. to about 165° F. The melted pine resin may be added in an amount that is about 5% to about 15% by volume to create mixture 50.

Once the constituents are combined, the mixture 50 may be heated to a range of about 260 F to about 280 F (e.g., about 270 F). The one or more binders may flow between the mineral constituents and granular material to fill in between and bind the dry mixture together in a reliably congealed and integral structure once cooled. In some examples, heating the mixture 50 results in the pine resin forming a film around (1) a mineral constituent comprising Scheelite ore, and/or (2) a metal constituent comprising tungsten, iron, and/or steel. The film is believed to reduce the reactivity of the ore and/or the metal constituent with other materials, including water or salt water.

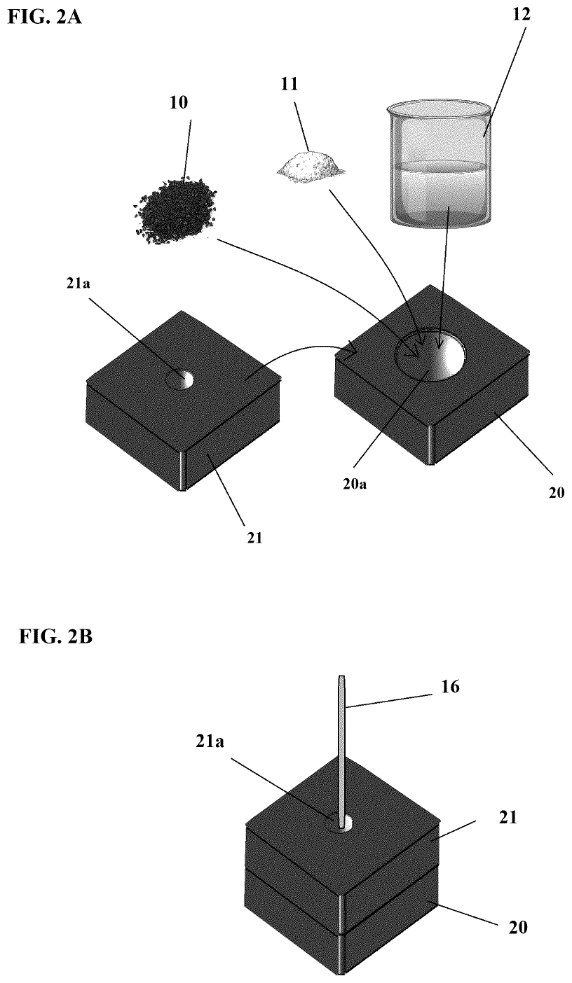

In some embodiments, a mold may be employed to form the fishing weight. The mixture 50 for the fishing weight can be molded in a mold structure 15 that is fabricated from various materials. The mold 15 may have two-part construction that allowed the dry mixture 50 to be placed in the mold 15 (the cell), which may include all of the volume of the weight and a press 25 that can be used to compress mixture in the mold. The press 25 may be a manual or automated press and may apply about 10 lbs. to about 20 lbs. of pressure (e.g., about 15 lbs. of pressure) to the mixture 50 in mold 15. The mold 15 may include a cavity may be configured to form various shapes for the lead-free fishing weights. FIGS. 2A-2D provide examples of fishing weights with various shapes.

FIGS. 2A-2B provides views of another method of manufacturing a lead-free fishing weight according to the present invention. The exemplary ingredients including the mineral and/or metal constituent 10, the coarse granular material 11, a naturally-occurring binder 12, and optionally a second naturally-occurring binder 13 are prepared for mixture in a mold. The mineral constituent and/or metal constituent may be combined in a dry mixture with the coarse granular material that includes from about 65% to about 85% mineral and/or metal constituent by volume and about 10% to about 20% coarse granular material by volume. A plurality of binders may be heated to their melting points and may be combined with the dry mixture. The first binder 12 may be pine resin, which has a melting point in a range of about 155° F. to about 165° F. The second binder 13 may be beeswax, which has a melting point in a range of about 144° F. to about 149° F. The melted pine resin may be added in an amount that is about 5% to about 15% by volume of the dry mixture, and melted beeswax may be added in an amount that is about 2.5% to about 7.5% by volume of the dry mixture.

Once the constituents are combined, the admixture may be heated to a range of about 260 F to about 280 F (e.g., about 270 F). The first and second binders may flow between the mineral and/or metal constituents and granular material to fill in between and bind the dry mixture together in a reliably congealed and integral structure once cooled. In some examples, heating the admixture results in the beeswax and pine resin forming a film around the mineral and/or metal constituents, which is believed to reduce the reactivity of the mineral and/or metal constituents with other materials, including water or salt water.

In some embodiments, the mold may have two-part construction that allowed the dry admixture to be placed in a lower portion of the mold 20 (the bed), which may include 50% or greater of the volume of the weight and an upper portion 21 (a cap) that encloses the admixture in the mold. The cap 21 may have a pour hole 21a formed through the center thereof. The pour hole 21a may have a diameter in a rage of about 3 mm to about 12 mm that allows the binders to be poured into the mold onto the admixture. A rod 16 may then be placed through the pour hole 21a in order to create a passage through the weight to allow fishing line to be threaded therethrough. The mold may be then placed in an oven and warmed to the target temperature.

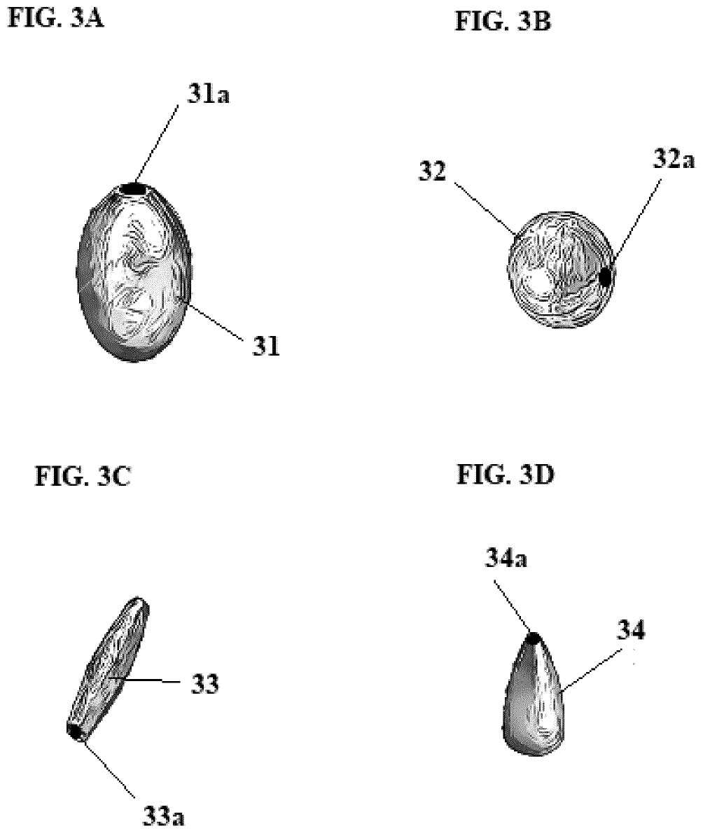

The lower portion of the mold 20 may include a cavity 20a that may provide a lower portion of the mold form cavity that forms and shapes the majority of the fishing weight. The upper portion 21 of the mold may include an upper portion of the mold form cavity that is exposed and shown through the pour hole 21a. The upper and lower portions of the mold form cavity may be configured to form various shapes for the lead-free fishing weights. FIGS. 3A-3D provide examples of fishing weights with various shapes. FIG. 3A provides a view an ellipsoid fishing weight 31 having a threading hole 31a to allow fishing line to be threaded therethrough. FIG. 3B provides a view a spherical fishing weight 32 having a threading hole 32a. FIG. 3C provides a view an extended, spindle-shaped fishing weight 33 having a threading hole 33a. FIG. 3D provides a view a teardrop-shaped fishing weight 34 having a threading hole 34a. The mold form cavity may be shaped in order for any of the shapes shown in FIGS. 3A-3D or other appropriate shapes.

### Example 1

In a particular example of the method of making the lead-free weight, the exemplary ingredients including the metal constituent 10 as a mixture of tungsten and iron particles in an amount of about 75% by weight, the coarse granular material 11 as sand in an amount of about 15% by weight, and the naturally-occurring binder 12 as pine resin in an amount of about 10% by weight. The components are combined and heated to about 270° F. and stirred or agitated. The mixture is then poured and pressed into a mold as shown in FIG. 1B. 15 lbs. of pressure are applied to the mixture in the mold using a mold press. The mixture is then allowed to cool to 75° F. before the fishing weight is removed from the mold. A hole having a diameter in a range of about 1 mm to about 5 mm for accepting fishing line is then formed through the fishing weight, e.g., with a drill.

### Example 2

In a particular example of the method of making the lead-free weight, the exemplary ingredients including a combination of mineral and metal constituent 10 as a mixture of Scheelite ore, tungsten, and iron particles in an amount of about 75% by weight, the coarse granular material 11 as sand in an amount of about 15% by weight, and the naturally-occurring binder 12 as pine resin in an amount of about 10% by weight. The components are combined and heated to about 270° F. and stirred or agitated. The mixture is then poured and pressed into a mold as shown in FIG. 1B. 15 lbs. of pressure are applied to the mixture in the mold using a mold press. The mixture is then allowed to cool to 75° F. before the fishing weight is removed from the mold. A hole having a diameter in a range of about 1 mm to about 5 mm for accepting fishing line is then formed through the fishing weight, e.g., with a drill.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A method of constructing lead-free weight comprising:
combining the following constituents in a mixture:
about 65% to about 85% metal constituent by volume,
about 10% to about 20% coarse granular material by volume, and
a naturally-occurring binder;
heating the mixture; and
heating the mixture to temperature in a range of about 260° F. to about 280° F.; and
allowing the heated mixture to set for a pre-determined period.

2. The method of claim 1, wherein said mineral element includes one or more of tungsten, iron, and steel.

3. The method of claim 1, wherein said mineral element comprises tungsten.

4. The method of claim 1, wherein said granular element includes one or more of coarse sand, pulverized stone, and granular calcium carbonate.

5. The method of claim 1, wherein the metal constituent may have an average size in a range of about 0.075 mm to about 0.25 mm.

6. The method of claim 1, wherein the coarse granular material may have an average size in a range of about 0.05 mm to about 0.5 mm.

7. The method of claim 1, wherein the first naturally-occurring binder is pine resin.

8. The method of claim 1, wherein the second naturally-occurring binder is beeswax.

9. The method of claim 1, wherein said naturally occurring binder is added in an amount that is between about 5% and about 15% of the mixture by volume.

10. The method of claim 1, further comprising adding a second naturally occurring binder in an amount that is between about 5% and about 10% of the dry mixture by volume.

11. The method of claim 1, further comprising placing said mixture in a mold after heating the mixture.

12. The method of claim 11, wherein said mixture is allowed to set in said mold for a pre-determined period prior to removal from said mold.

13. The method of claim 1, further comprising placing said mixture in a pre-selected mold and allowing the mixture to cool for a pre-determined period

14. A lead-free weight comprising:
a pre-determined shape operable to be attached to fishing line;
about 65% to about 85% of a combination of mineral and metal constituents by volume;
about 10% to about 20% coarse granular material by volume; and
a naturally occurring binder coating the mineral constituent and the coarse granular constituent on the exterior of the weight and being present interstitially between the mineral constituent and the coarse granular constituent.

15. The weight of claim 14, wherein said mineral element includes one or more of Scheelite, Wolframite, Cassiterite, Chromite, Ilmenite, and Rutile.

16. The weight of claim 14, wherein said metal element includes one or more of tungsten, iron, and steel.

17. The weight of claim 14, wherein said granular element includes one or more of coarse sand, pulverized stone, and granular calcium carbonate.

18. The weight of claim 14, wherein the mineral constituent may have an average size in a range of about 0.075 mm to about 0.25 mm.

19. The weight of claim 14, wherein the coarse granular material may have an average size in a range of about 0.05 mm to about 0.5 mm.

20. The weight of claim 14, wherein said naturally occurring binder is pine resin and is added in an amount that is between about 5% and about 15% of the dry mixture by volume.
